(19) United States
(12) Patent Application Publication
(10) Pub. No.: US 2015/0121342 A1
(43) Pub. Date: Apr. 30, 2015

(54) METHOD OF THREAD SAFETY VERIFICATION AND FEEDBACK

(71) Applicant: International Business Machines Corporation, Armonk, NY (US)

(72) Inventors: Hisham Abdel-Hafez, Giza (EG); Hisham E. El-Shishiny, Cairo (EG); Khaled Ghareeb, Cairo (EG); Ahmed A. Saleh, Cairo (EG)

(73) Assignee: International Business Machines Corporation, Armonk, NY (US)

(21) Appl. No.: 14/065,748

(22) Filed: Oct. 29, 2013

(51) Int. Cl. G06F 11/36

(52) U.S. Cl. CPC G06F 11/3672
USPC 717/124

(57) ABSTRACT

A computer-implemented method, computer program product, and computer system for testing thread hazards in a multi-threaded software program. The present invention uses UML (Universal Modeling Language) models and system KPIs (Key Performance Indicators) to check whether a multi-threaded software program is thread safe and within performance boundaries. The present invention provides solutions for resolving the thread safety problems or provides the designer feedback for helping a designer of multi-threaded software program avoid the thread safety problems.

### FIELD OF THE INVENTION

The present invention relates generally to testing for thread hazards in a multi-threaded software program. In particular, the present invention relates to a method for identifying thread safety and verification in a multi-threaded software program.

### BACKGROUND

A main problem with threaded programming is that it suffers from main hazards, i.e., race conditions and deadlocks. In a race condition, two or more threads are accessing and trying to change a shared resource at the same time. In a deadlock, two or more threads are unable to continue their jobs because each thread is waiting for one of the other threads to finish its job.

The multi-threading hazards are always hard to detect during design and implementation when software programs become larger and more complicated. Multi-threading problems always appear during field testing of the program. Late detection of threading problems causes project deterioration. Hence, providing a tool for verifying and advising about the hazards is important in multi-threaded programming.

The current procedures for managing the multi-threading hazards suffer from one or more of the following problems. (1) The current procedures don't detect the thread's hazards early, but they rather try to solve them after detecting them during runtime. (2) The current procedures don't guarantee that new hazards are not introduced into the software due to applying these procedures. (3) The current procedures don't take the overall system performance into consideration. Given the above, it is clear that designers need a tool or a method that can verify the thread safety of the designed system. Developers need to obtain insight on possible solutions to resolve thread safety problems in their designs, or hints on how to modify the designs to avoid these thread safety problems.

### SUMMARY

Embodiments of the present invention provide a computer-implemented method, computer program product, and computer system for testing thread hazards in a multi-threaded software program. The computer system receives initially assigned priorities for respective threads; the initially assigned priorities are based on Universal Modeling Language (UML). The computer system selects a thread with a lowest priority as a current thread, from one or more threads that have not been tested. The computer system raises a priority of the current thread just above a lowest competing thread that has not been tested. The computer system tests the current thread for key performance indicators (KPIs).

### BRIEF DESCRIPTION OF THE SEVERAL VIEWS OF THE DRAWINGS

FIG. 1 is a diagram illustrating components of a thread safety verification and feedback program, in accordance with an exemplary embodiment of the present invention.

FIG. 2 is a flowchart illustrating operating steps of the thread safety verification and feedback program shown in FIG. 1, in accordance with an exemplary embodiment of the present invention.

FIG. 3 is a diagram illustrating components of a computing device hosting the thread safety verification and feedback program shown in FIG. 1, in accordance with an exemplary embodiment of the present invention.

### DETAILED DESCRIPTION

Embodiments of the present invention propose a method for detecting thread hazards and its effect on the overall system performance. The method uses UML (Universal Modeling Language) models and system KPIs (Key Performance Indicators) to check whether a multi-threaded software program is thread safe and within performance boundaries. UML is a general-purpose modeling language in the field of software engineering. The Unified Modeling Language includes a set of graphic notation techniques to create visual models of object-oriented software-intensive systems. KPIs, for example, include memory, thread context, page swaps, caching, processing power, network overhead, etc. The main advantages of the present invention are as follows. The present invention provides a tool to check possible thread hazards during design and implementation time in an automated way and avoids project deterioration due to late detection of design and implementation errors related to thread safety. The method disclosed in the present invention uses UML modeling programs; therefore, the method is in harmony with any software development process. The method disclosed in the present invention provides solutions for resolving the thread safety problems and/or provides the designer feedback for helping the designer avoid the thread safety problems.

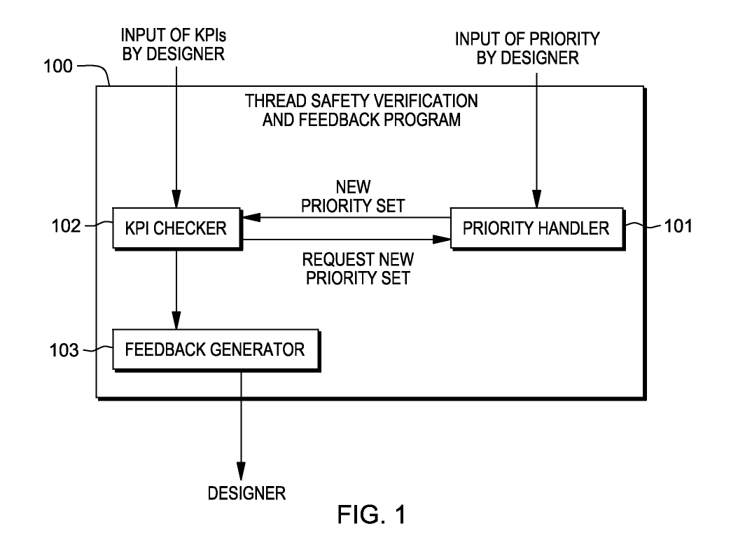

FIG. 1 is a diagram illustrating components of thread safety verification and feedback program 100, in accordance with an exemplary embodiment of the present invention. Thread safety verification and feedback program 100 comprises priority handler 101, KPI checker 102, and feedback generator 103.

Thread priorities are initially extracted from the given UML model. Priority handler 102 receives the initial priorities of threads from the designer based on UML diagrams. In order to resolve the thread safety problem, thread safety verification and feedback program 100 has an iterative procedure. In the interactive procedure, KPI checker 102 requests priority handler 101 a new priority set; priority handler 101 changes the priorities of threads and provides KPI checker 102 with a new priority set. KPI checker 102 runs standard tests to verify whether all KPIs, which are input by the designer, are within the given boundaries. KPI checker 102 stops when priority handler 101 finds a set of priorities making the system within KPI boundaries or when no priorities can resolve the thread safety problem. In the former case, feedback generator 103 provides a list of priorities that will resolve the thread safety problems. In the latter case, feedback generator 103 provides the designer with feedback, which helps the designer improve programming design to avoid the thread safety problem.

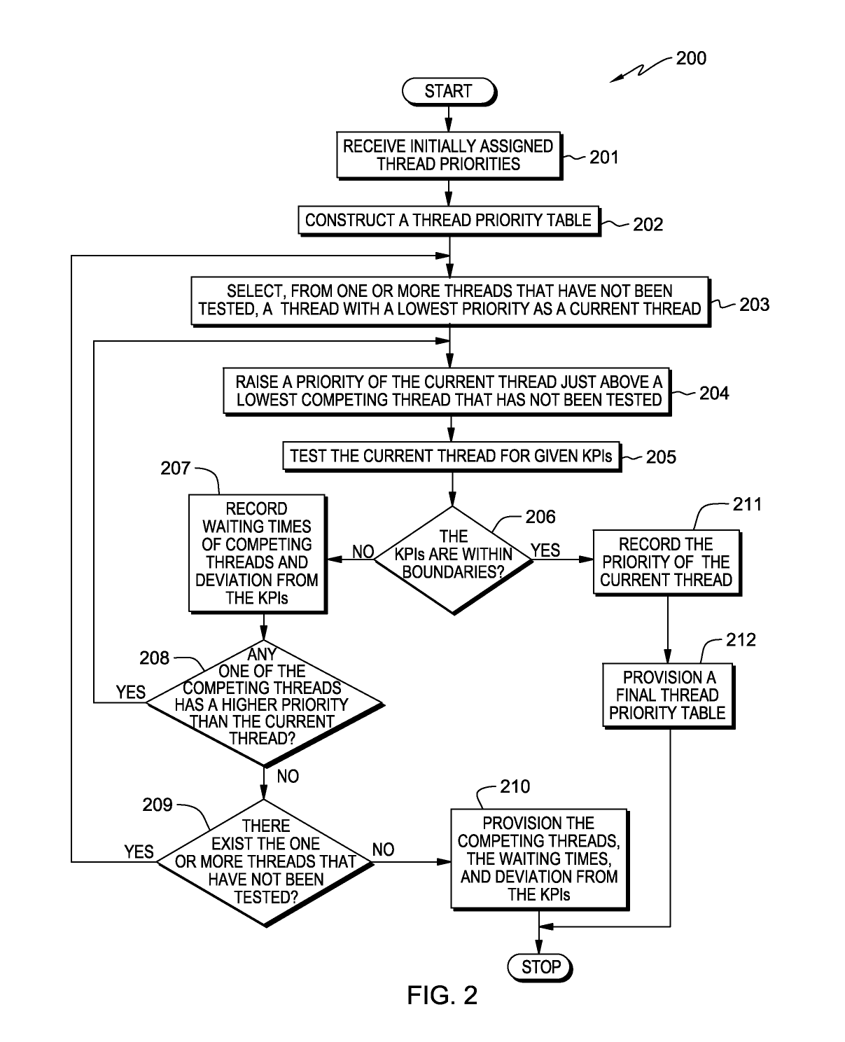

FIG. 2 is flowchart 200 illustrating operating steps of thread safety verification and feedback program 100 shown in FIG. 1, in accordance with an exemplary embodiment of the present invention. At step 201, thread safety verification and feedback program 100 receives, from the designer, initially assigned thread priorities which are based on the development of UML diagrams. At step 202, thread safety verification and feedback program 100, from the UML diagrams, constructs a thread priority table. In the exemplary embodiment, the thread priority table is in a descending order of the thread priorities. An illustrative example of the thread priority table is as shown in Table 1. In the example shown in Table 1, multiple threads include Thr_{—}1, Thr_{—}9, Thr_{—}13, and Thr_{—}27 which have priorities of 1, 2, 3, and 4, respectively. Among the multiple threads, Thr_{—}1 has the highest priority and Thr_{—}27 has the lowest priority. For example, Thr_{—}1 has competing threads Thr_{—}9, Thr_{—}13, and Thr_{—}27 which compete on resources with Thr_{—}1.

TABLE 1

| Thread ID | Thread Priority | Competing Thread IDs |
|---|---|---|
| Thr_1 | 1 | Thr_9, Thr_13, Thr_27 |
| Thr_9 | 2 | Thr_1, Thr_13, Thr_27 |
| Thr_13 | 3 | Thr_1, Thr_9, Thr_27 |
| Thr_27 | 4 | Thr_1, Thr_9, Thr_13 |

Referring to FIG. 2, at step 203, thread safety verification and feedback program 100 selects, from one or more threads that have not been tested, a thread with a lowest priority as a current thread. In the example given in Table 1, before any thread is tested, Thr_{—}27 is selected as a current thread because Thr_{—}27 has a lowest priority among Thr_{—}1, Thr_{—}9, Thr_{—}13, and Thr_{—}27; in a next cycle after executing decision block 209, Thr_{—}1, Thr-9, and Thr_{—}13 remain untested and therefore Thr_{—}13 is selected as a current thread because Thr_{—}13 has a lowest priority among untested threads. More cycles after executing decision block 209 may go on.

At step 204, thread safety verification and feedback program 100 raises a priority of the current thread just above a lowest competing thread that has not been tested. In the example given in Table 1, Thr_{—}27 is selected as the current thread at step 203 and Thr_{—}27 has competing threads Thr_{—}1, Thr_{—}9, and Thr_{—}13. Priorities of Thr_{—}1, Thr_{—}9, and Thr_{—}13 are higher than that of Thr_{—}27, and the priority of Thr_{—}27 is below that of Thr_{—}13. The priority of the current thread is raised to just above Thr_{—}13, and thus priorities of the multiple threads become 1 for Thr_{—}1, 2 for Thr_{—}9, 3 for Thr_{—}27, and 4 for Thr_{—}13. In a next cycle after executing decision block 208, priorities of Thr_{—}1 and Thr_{—}9 are higher than that of Thr_{—}27, and the priority of Thr_{—}27 is below that of Thr_{—}9; therefore, thread safety verification and feedback program 100 raises the priority of Thr_{—}27 just above Thr_{—}9 and sets priorities as 1 for Thr_{—}1, 2 for Thr_{—}27, 3 for Thr_{—}9, and 4 for Thr_{—}13. More cycles after executing decision block 208 may go on.

At step 205, thread safety verification and feedback program 100 tests the current thread for given key performance indicators (KPIs) by running standard tests. KPIs, for example, include memory, thread context, page swaps, caching, processing power, network overhead, etc. The standard tests are known tests, available through the operating system provider or the application provider, to check the status of system resources.

At decision block 206, thread safety verification and feedback program 100 determines whether the KPIs are within boundaries. In response to determining that the KPIs are within boundaries (“YES” branch of decision block 206), at step 211, thread safety verification and feedback program 100 records the thread priority of the current thread. At step 212, thread safety verification and feedback program 100 provisions a final thread priority table.

In response to determining that the KPIs are not within boundaries (“NO” branch of decision block 206), at step 207, thread safety verification and feedback program 100 records waiting time of competing threads of the current thread and deviation from the KPIs.

At decision block 208, thread safety verification and feedback program 100 determines whether any one of the competing threads has a higher priority than the current thread. In response to determining that at least one of the competing threads has the higher priority than the current thread (“YES” branch of decision block 208), thread safety verification and feedback program 100 reiterates step 204. In response to determining that no one of the competing threads has the higher priority than the current thread (“NO” branch of decision block 208), thread safety verification and feedback program 100, at decision block 209, determines whether there exist the one or more threads that have not been tested.

In response to determining that there exist the one or more threads that have not been tested (“YES” branch of decision block 209), thread safety verification and feedback program 100 reiterates step 203. In response to determining that there do not exist the one or more threads that have not been tested (“NO” branch of decision block 209), thread safety verification and feedback program 100 provisions information on the competing threads, the waiting times of the competing threads, and the deviation from the KPIs.

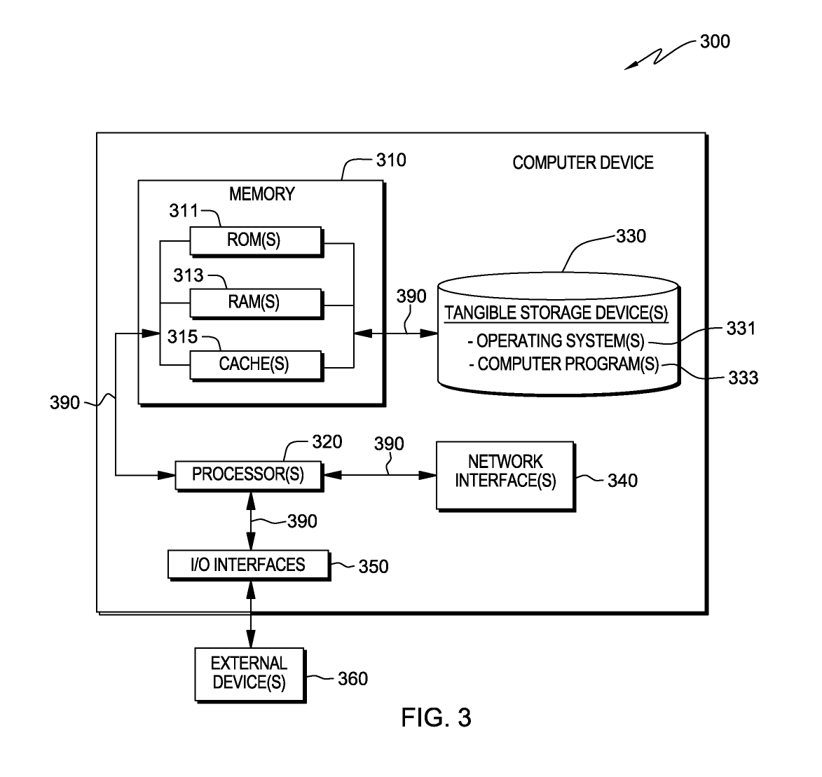

FIG. 3 is a diagram illustrating components of a computing device hosting thread safety verification and feedback program 100 shown in FIG. 1, in accordance with an exemplary embodiment of the present invention. It should be appreciated that FIG. 3 provides only an illustration of one implementation and does not imply any limitations with regard to the environment in which different embodiments may be implemented. In other embodiments, priority handler 101, KPI checker 102, and feedback generator 103 (shown in FIG. 1) of thread safety verification and feedback program 100 may reside respectively on multiple computer devices.

Referring to FIG. 3, computing device 300 includes processor(s) 320, memory 310, tangible storage device(s) 330, network interface(s) 340, and I/O (input/output) interface(s) 350. In FIG. 3, communications among the above-mentioned components of computing device 300 are denoted by numeral 390. Memory 310 includes ROM(s) (Read Only Memory) 311, RAM(s) (Random Access Memory) 313, and cache(s) 315.

One or more operating systems 331 and one or more computer programs 333 reside on one or more computer-readable tangible storage device(s) 330. In the exemplary embodiment, thread safety verification and feedback program 100 resides on one or more computer-readable tangible storage device(s) 330.

Computing device 300 further includes I/O interface(s) 350. I/O interface(s) 350 allow for input and output of data with external device(s) 360 that may be connected to computing device 300. Computing device 300 further includes network interface(s) 340 for communications between computing device 300 and a computer network.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by, or in connection with, an instruction execution system, apparatus, or device.

Program code embodied on a computer readable medium may be transmitted using any appropriate medium including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture, including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for testing thread hazards in a multi-threaded software program, comprising steps of:
receiving, for respective threads, priorities which are initially assigned based on Universal Modeling Language;
selecting, from one or more threads that have not been tested, a thread with a lowest priority as a current thread;
raising a priority of the current thread just above a lowest competing thread that has not been tested; and
testing the current thread for key performance indicators.

2. The computer-implemented method of claim 1, further comprising steps of testing the current thread for key performance indicators:
determining whether the key performance indicators of the current thread are within boundaries;
recording the priority of the current thread, in response to determining that the key performance indicators of the current thread are within boundaries; and
provisioning a final thread priority table.

3. The computer-implemented method of claim 1, further comprising steps of testing the current thread for key performance indicators:
determining whether the key performance indicators of the current thread are within boundaries;
recording waiting times of competing threads and deviations from the key performance indicators, in response to determining that the key performance indicators of the current thread are not within boundaries; and
determining whether any one of the competing threads has a higher priority than the current thread.

4. The computer-implemented method of claim 3, further comprising a step of:
determining whether there exist the one or more threads that have not been tested, in response to determining that no one of the competing threads has the higher priority than the current thread.

5. The computer-implemented method of claim 4, further comprising a step of: provisioning information on the competing threads, the waiting times of the competing threads, and deviation from the key performance indicators, in response to determining that there do not exist the one or more threads that have not been tested.

6. The computer-implemented method of claim 4, further comprising steps of:
selecting, from the one or more threads that have not been tested, another thread with the lowest priority as the current thread, in response to determining that there exist the one or more threads that have not been tested;
raising a priority of the another thread just above the lowest competing thread that has not been tested; and
reiterating the steps of testing the current thread for key performance indicators.

7. The computer-implemented method of claim 3, further comprising steps of:
raising the priority of the current thread just above the lowest competing thread that has not been tested, in response to determining that at least one of the competing threads has the higher priority than the current thread; and
reiterating the steps of testing the current thread.

8. A computer program product for testing thread hazards in a multi-threaded software program, the computer program product comprising a computer readable storage medium having program code embodied therewith, the program code executable to:
receive, for respective threads, priorities which are initially assigned based on Universal Modeling Language;
select, from one or more threads that have not been tested, a thread with a lowest priority as a current thread;
raise a priority of the current thread just above a lowest competing thread that has not been tested; and
test the current thread for key performance indicators.

9. The computer program product of claim 8, further comprising program code to test the current thread for key performance indicators, executable to:
determine whether the key performance indicators of the current thread are within boundaries;
record the priority of the current thread, in response to determining that the key performance indicators of the current thread are within boundaries; and
provision a final thread priority table.

10. The computer program product of claim 8, further comprising program code to test the current thread for key performance indicators, executable to:
determine whether the key performance indicators of the current thread are within boundaries;
record waiting times of competing threads and deviations from the key performance indicators, in response to determining that the key performance indicators of the current thread are not within boundaries; and
determine whether any one of the competing threads has a higher priority than the current thread.

11. The computer program product of claim 10, the program code further executable to: determine whether there exist the one or more threads that have not been tested, in response to determining that no one of the competing threads has the higher priority than the current thread.

12. The computer program product of claim 11, the program code further executable to: provision information on the competing threads, the waiting times of the competing threads, and deviation from the key performance indicators, in response to determining that there do not exist the one or more threads that have not been tested.

13. The computer program product of claim 11, the program code further executable to:
select, from the one or more threads that have not been tested, another thread with the lowest priority as the current thread, in response to determining that there exist the one or more threads that have not been tested;
raise a priority of the another thread just above the lowest competing thread that has not been tested; and
reiterate the program code to test the current thread for key performance indicators.

14. The computer program product of claim 10, the program code further executable to:
raise the priority of the current thread just above the competing thread that has not been tested, in response to determining that at least one of the competing threads has the higher priority than the current thread; and
reiterate the program code to test the current thread for key performance indicators.

15. A computer system for testing thread hazards in a multi-threaded software program, the computer system comprising:
one or more processors, one or more computer-readable tangible storage devices, and program instructions stored on at least one of the one or more computer-readable tangible storage devices for execution by at least one of the one or more processors, the program instructions executable to:
receive, for respective threads, priorities which are initially assigned based on Universal Modeling Language;
select, from the one or more threads that have not been tested, a thread with a lowest priority as a current thread;
raise a priority of the current thread just above a lowest competing thread that has not been tested; and
test the current thread for key performance indicators.

16. The computer system of claim 15, further comprising program instructions to test the current thread for key performance indicators, executable to:
determine whether the key performance indicators of the current thread are within boundaries;
record the priority of the current thread, in response to determining that the key performance indicators of the current thread are within boundaries; and
provision a final thread priority table.

17. The computer system of claim 15, further comprising program instructions to test the current thread for key performance indicators, executable to:
determine whether the key performance indicators of the current thread are within boundaries;
record waiting times of competing threads and deviations from the key performance indicators, in response to determining that the key performance indicators of the current thread are not within boundaries; and
determine whether any one of the competing threads has a higher priority than the current thread.

18. The computer system of claim 17, the program instructions further executable to:
determine whether there exist the one or more threads that have not been tested, in response to determining that no one of the competing threads has the higher priority than the current thread.

19. The computer system of claim 18, the program instructions further executable to:
in response to determining that there do not exist the one or more threads that have not been tested, provision information on the competing threads, the waiting times of the competing threads, and deviation from the key performance indicators; and
in response to determining that there exist the one or more threads that have not been tested, select, from the one or more threads that have not been tested, another thread with the lowest priority as the current thread, raise a priority of the another thread just above the lowest competing thread that has not been tested, reiterate the program instructions to test the current thread for key performance indicators.

20. The computer system of claim 17, the program instructions further executable to:
raise the priority of the current just above the lowest competing thread that has not been tested, in response to determining that at least one of the competing threads has the higher priority than the current thread; and
reiterate the program instructions to test the current thread for key performance indicators.
